(19) United States
(12) Patent Application Publication
(10) Pub. No.: US 2006/0045118 A1
(43) Pub. Date: Mar. 2, 2006

(54) Communication system using near field and method thereof

(76) Inventors: Chang Hee Hyoung, Daejeon (KR); Sung Weon Kang, Daejeon (KR); Chang Auck Choi, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/028,824

(22) Filed: Dec. 21, 2004

(30) Foreign Application Priority Data
Sep. 1, 2004 (KR) 2004-69590

(51) Int. Cl. H04L 12/413

(52) U.S. Cl. 370/445

(57) ABSTRACT

Provided is a communication system using a near field and a method thereof, which uses a conductive medium, i.e., a human body, and comprises a plurality of peripheral devices having a communication device for transmitting and receiving a predetermined data signal through the near field formed around the human body, using a carrier sense multiple access with collision detection (CSMA/CD) method, thereby solving a directional problem of an antenna when the wireless system is used and achieving miniaturization, as well as enhancing communication efficiency by using the most appropriate frequency to the human communication without collision of transmitting and receiving signals between the plurality of peripheral devices.

### CROSS-REFERENCE TO RELATED APPLICATION

This application claims the benefit of Korea Patent Application No. 2004-69590 filed on Sep. 1, 2004, the disclosure of which is hereby incorporated herein by reference in its entirety.

### BACKGROUND

1. Field of the Invention

The present invention generally relates to a communication system using a near field and a method thereof, and more particularly, to a communication system using a near field and a method thereof, which uses a conductive medium, i.e., a human body as a communication line, and includes a plurality of peripheral devices having a communication device for transmitting and receiving a predetermined data signal through a near field formed around the human body using a carrier sense multiple access with collision detection (CSMA/CD) method, thereby enhancing communication efficiency by using the most appropriate frequency to a human body communication without collision of transmitting and receiving signals between the plurality of peripheral devices.

2. Discussion of Related Art

In general, in the existing communication system using a human body as a medium, a signal modulated by modulation means of a transmitting device is applied to the human body, which is a medium, through an externally exposed conductive electrode, and is transmitted to a conductive electrode arranged at a receiving device, and then is demodulated to an original signal by demodulation means. Since an additional line is not required as a transmission medium, the existing communication system using the human body may be regarded as a wireless system.

Therefore, locations between the transmitting device and the receiving device may be freely arranged because of no needs of antennas and the power required in the transmitting device and the receiving device is small. As a result, the existing communication system using the human body may be applied to a portable device.

As described above, the communication system using the human body as a medium has been used in a variety of application fields. For example, a method of using a coupling system around the human body to make an encrypted communication with an identification card has been used in a variety of credit cards, ID cards and access cards. Here, in the existing communication system using the human body as a medium, the communication is established by handshaking or other physical contacts.

The communication system using the human body as a medium may be largely classified into an intra-body communication system, which makes communication between peripheral devices attached to one human body and between fixed peripheral devices and the peripheral devices attached to one human body, and an inter-body communication system, which makes communication between the human bodies. For both communication systems, there are couplings between peripheral devices and the human body, or a medium, via physical interfaces in the transmitting device and the receiving device, respectively.

However, most of the conventional communication systems using a near field formed around the human body are composed of one transmitter and one receiver located or mounted around the human body. Thus, when the communication system includes a plurality of transmitters and receivers on the human body, which indicates one communication channel, to configure the communication system, signals transmitted and received through the human body may be collided with each other. Therefore, troubles may occur in the system.

### SUMMARY OF THE INVENTION

The present invention is directed to a communication system using a near field, which uses a conductive medium, i.e., a human body as a communication line, and includes a plurality of peripheral devices having a communication device for transmitting and receiving a predetermined data signal through a near field formed around the human body, by a carrier sense multiple access with collision detection (CSMA/CD) method, thereby solving a directional problem of an antenna when the wireless system is used and achieving miniaturization.

The present invention is also directed to a communication system using a near field, which controls data signals transmitted and received by a CSMA/CD method to transmit each of a plurality of data signals through the near field formed around at least one medium having conductivity, i.e., a human body, receive each of the plurality of data signals transmitted through the human body, and prevent collision between the transmitted and received signals, thereby enhancing communication efficiency using the most appropriate frequency to the human communication without collision of transmitting and receiving signals between the plurality of peripheral devices.

One aspect of the present invention is to provide a communication system using a near field comprising: at least one medium having conductivity; and a plurality of peripheral devices arranged around the medium and having a communication device used to transmit and receive a predetermined data signal using a carrier sense multiple access with collision detection (CSMA/CD) method through the near field formed around the medium.

Another aspect of the present invention is to provide a communication method using a near field comprising: transmitting a plurality of data signals, respectively, through a near field formed around at least one medium having conductivity; receiving the respective data singles transmitted through the medium; and controlling the transmitted and received data signals using a carrier sense multiple access with collision detection (CSMA/CD) method to prevent collision between the transmitted and received data signals.

### BRIEF DESCRIPTION OF THE DRAWINGS

The foregoing and other objects, features and advantages of the invention will be apparent from the more particular description of a preferred embodiment of the invention, as illustrated in the accompanying drawing. The drawing is not necessarily to scale, emphasis instead being placed upon illustrating the principles of the invention.

FIG. 1 is a schematic diagram illustrating a communication system using a near field according to an embodiment of the present invention.

FIG. 2 is a detailed block diagram illustrating a communication system using a near field according to an embodiment of the present invention.

FIG. 3 is a flow chart illustrating a communication method using a near field according to an embodiment of the present invention.

FIG. 4 is a diagram illustrating operating states of peripheral devices in a communication method using a near field according to an embodiment of the present invention.

FIG. 5 is a schematic diagram illustrating a communication system using a near field according to another embodiment of the present invention.

### DETAILED DESCRIPTION OF PREFERRED EMBODIMENTS

Exemplary embodiments of the present invention will now be described in detail with reference to the accompanying drawings. However, a variety of modifications may be made to the following illustrated embodiments, which are provided to describe the present invention thoroughly to those skilled in the art.

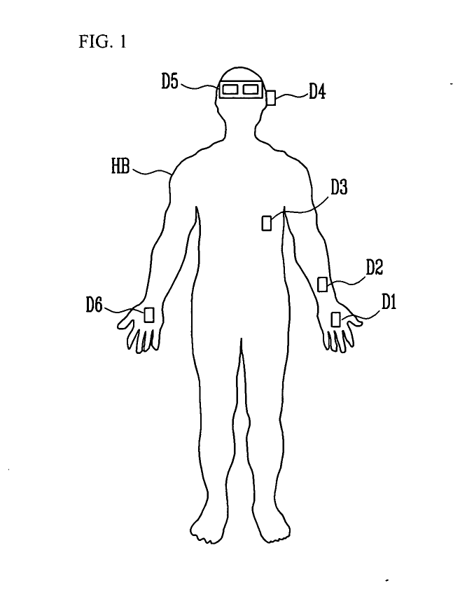

FIG. 1 is a schematic diagram illustrating a communication system using a near field according to an embodiment of the present invention;

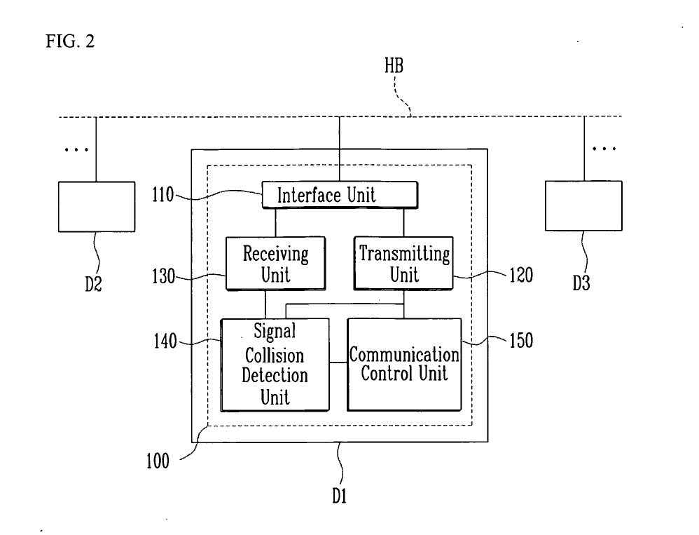

Referring to FIG. 1, a communication system using a near field according to an embodiment of the present invention is composed of a plurality of peripheral devices D1 to D6 having communication devices 100 (in FIG. 2) arranged around a conductive medium, i.e., a human body (HB), and used to transmit and receive predetermined data signals using a carrier sense multiple access with collision detection (CSMA/CD) method via the near field formed around the human body (HB).

Here, the medium is used as one communication line, which is preferably, but not limited to, the human body (HB). Thus, the medium may be composed of a material having high resistance such as water or a solution where predetermined chemical substances are resolved.

The predetermined data signals may be composed of character signals, video signals, audio signals, and physiological signals detected from the human body.

The peripheral devices D1 to D6 are closely arranged or attached to the human body (HB), and are coupled to the human body (HB) through a physical interface, e.g., predetermined electrodes. The peripheral devices D1 to D6, which are portable and wearable devices, may be composed of a communication device D1 such as a mobile phone, a clock D2, a medical sensor D3, an audio device D4 such as a headphone or an earphone, an image display device D5, and an arithmetic processing device D6 having arithmetic and processing capability such as personal digital assistants (PDA).

The carrier sense multiple access with collision detection (CSMA/CD) method is generally applied to the network system. According to the present invention, it is configured to check data signals transmitted and received between a plurality of peripheral devices D1 to D6 to prevent collisions between signals while using the same frequency. For example, with a configuration having a communication control unit 150 and a signal collision detection unit 140 of the communication device 100 described below, included in the peripheral devices D1 to D6, it is possible to efficiently prevent collisions between the transmitted and received data signals.

FIG. 2 is a detailed block diagram illustrating a communication system using a near field according to an embodiment of the present invention;

Referring to FIG. 2, a communication device 100 that transmits and receives signals modulated and demodulated by using a certain frequency is arranged in a plurality of peripheral devices D1 to D6 for communication with each other through a near field formed around a human body (HB).

The communication device 100 includes an interface unit 110, a transmission unit 120, a receiving unit 130, a signal collision detection unit 140 and a communication control unit 150.

The interface unit 110, which is used to couple with the human body (HB) or a medium, serves to transmit signals to the human body (HB) using a near field at the close distance and may be implemented with a material having good conductivity, e.g., an electrode.

The transmission unit 120, which serves to modulate a predetermined data signal using a predetermined frequency, modulates the data signals generated from the communication control unit 150 using a frequency appropriate to the human body communication to output to the interface unit 110. Here, it is desirable that the modulation frequency is a specific frequency (e.g., several KHz to several tens of MHz) selected from the existing experiment using the human body. In addition, the data signal generated from the communication control unit 150 may be modulated using a appropriate frequency to human body communications such as amplitude shift keying (ASK) or frequency shift keying (FSK) etc.

The receiving unit 130 serves to receive the modulated signals from the transmission unit of other peripheral devices through the interface unit 110 to demodulate the signals into original signals, and applies the original signals to the signal collision detection unit 140 and the communication control unit 150 to recognize the communication line state of the human body (HB). Here, the original signals may be composed of character signals, video signals, audio signals and physiological signal detected from the human body. In addition, various circuits included in the existing peripheral devices such as coding circuits for obtaining the original signals and memories may also be arranged.

The signal collision detection unit 140 is used to compare each of the data signals transmitted and received from the transmission unit 120 and the receiving unit 130 to output a predetermined collision detection signal for preventing the collisions between the data signals transmitted and received between the plurality of peripheral devices D1 to D6. By comparing, bit by bit, the currently transmitted data signals with the data signals received from the receiving unit 130 at the time of transmitting the data signal transmitted from the transmission unit 120, in the case that the bit of the data signal different from that of the currently transmitted data signal is received, the signal collision detection unit 140 determines that the communication with other peripheral devices is established on the current human body (HB) communication line to output the predetermined collision detection signal to the communication control unit 150.

The communication control unit 150 controls inputs and outputs of the data signals transmitted and received from the transmission unit 120 and the receiving unit 130, respectively, based on the predetermined collision detection signal outputted from the signal collision detection unit 140, and periodically checks the communication state of the human body (HB) or the medium. In other words, when the collision detection signal is detected in the step of preparing transmission, the communication control unit 150 keeps checking the human body (HB) communication line while maintaining any wait state.

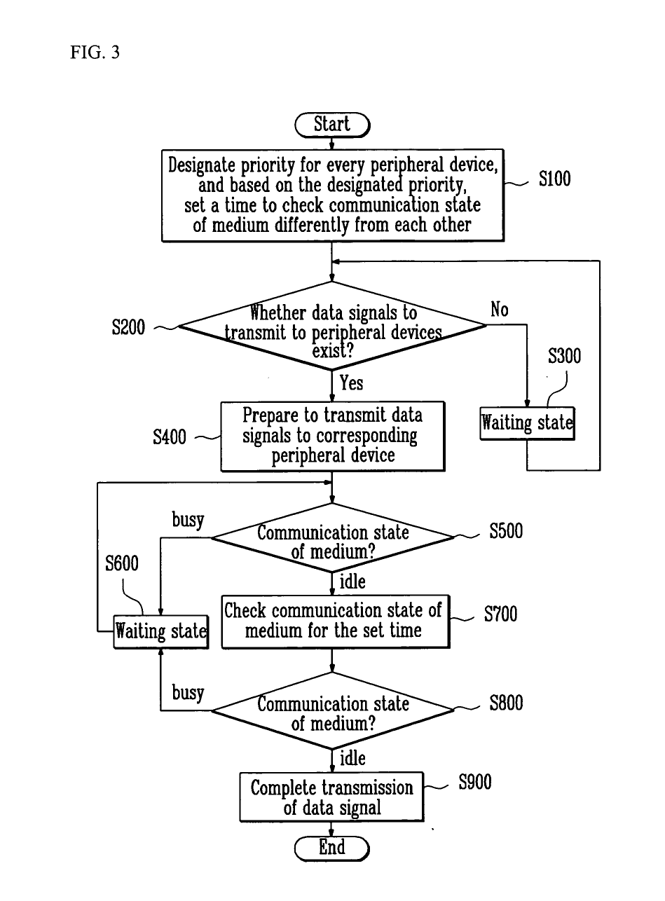

FIG. 3 is a flow chart illustrating a communication method using a near field according to an embodiment of the present invention. Note that this communication method is mainly performed with the communication control unit 150 unless stated otherwise. Further, this functionality may be included in the control unit among the existing peripheral devices.

Referring to FIG. 3, first, at step S100, a priority for each of the peripheral devices D1 to D6 is designated, and based on the designated priority, a time to check the communication state of the human body (HB) or the medium, is set differently from each other. Here, the peripheral devices D1 to D6 are arranged removably rather than fixedly on the human body (HB). Among them, there may be two devices having the same function. In this case, it may be difficult to designate a priority to every peripheral device D1 to D6 in advance, so that a certain signal generator may be used.

Next, proceeding to step S200, it is determined whether there exist data signals to be transmitted to other peripheral devices or not. If not so, proceeding to step S300, the wait state is maintained for a certain time. Next, returning to step S200, it is determined again whether there exist data signals to be transmitted or not.

Further, as a result of the determination in the step S200, when there are data signals to be transmitted, the process proceeds to step S400 to prepare transmission of data signals to the corresponding peripheral devices. Here, the transmission preparation of the data signals is preferably performed such that packet data signals are generated in a packet unit composed of a plurality of byte data signals through the corresponding communication device 100, i.e., the communication control unit 150, and the packet data signals are converted to high-frequency signals appropriate to the communication with the human body (HB) or the medium.

Next, at step S500, the communication state of the human body (HB) or the medium, is determined. In the case that the communication state of the human body (HB) between the peripheral devices D1 to D5 is busy, the process proceeds to step S600. And then, after waiting for a certain time, the process returns to the step S500 so that the communication state of the human body (HB) is determined again.

Further, as a result of the determination in the step S500, in the case that the communication state of the human body (HB) between the peripheral devices D1 to D6 is not busy, i.e, in the idle state, the process proceeds to step S700. At S700, the communication state of the human body is checked for a time to check the communication state of the human body (HB) determined at the step S100.

Next, at step S800, the communication state of the human body (HB) or the medium, is determined, and in the case that the communication state of the human body (HB) between the peripheral devices D1 to D6 is busy, the process returns to the step S600 to maintain the wait state for a certain time.

Further, as a result of the determination in the step S800, in the case that the communication state of the human body (HB) between the peripheral devices D1 to D6 is not busy, i.e, in the idle state, the process proceeds to step S900 to complete the transmission of the data signals.

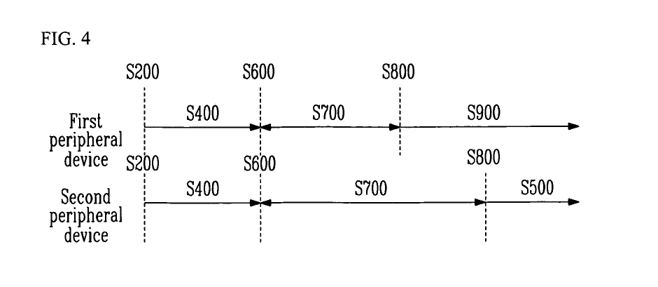

FIG. 4 is a diagram illustrating operational states of peripheral devices in a communication method using a near field according to an embodiment of the present invention.

Referring to FIG. 4, after preparing the transmission of first and second peripheral devices in the same manner (S400), when the communication state of the human body (HB) is checked for a predetermined time to check the communication state of the human body (HB) (S700), it is assumed that a priority of the first peripheral device is higher than that of the second peripheral device, and the time to check the communication state of the human body (HB) for the first peripheral device is defined shorter than that for the second peripheral device.

Therefore, even when the first and second peripheral devices starts at the same timing to check the communication state of the human body (HB) and keeps checking the communication state of the human body (HB), the time to check the communication state of the human body (HB) is ended earlier for the first peripheral device to transmit the data signals (S900).

Further, later, even when the time to check the communication state of the human body (HB) for the second peripheral device is ended, since the first peripheral device uses the current human body (HB) communication line, the second peripheral device falls into the wait state to prevent collision between the first and second peripheral devices (S500).

When it is difficult to allocate different time to check the communication state of the human body (HB) for each of the peripheral devices as described above, a delay time generated by a certain signal generator may be generated to keep checking the communication state of the human body (HB) for the time to check the communication state of the human body (HB). In this case, the first peripheral device does not always have a priority over the second peripheral device. In addition, in the case that a certain signal generator is used, and when the peripheral device preoccupying the communication line of the human body (HB) establishes communication, the other peripheral device should wait until the communication line of the human body (HB) becomes idle.

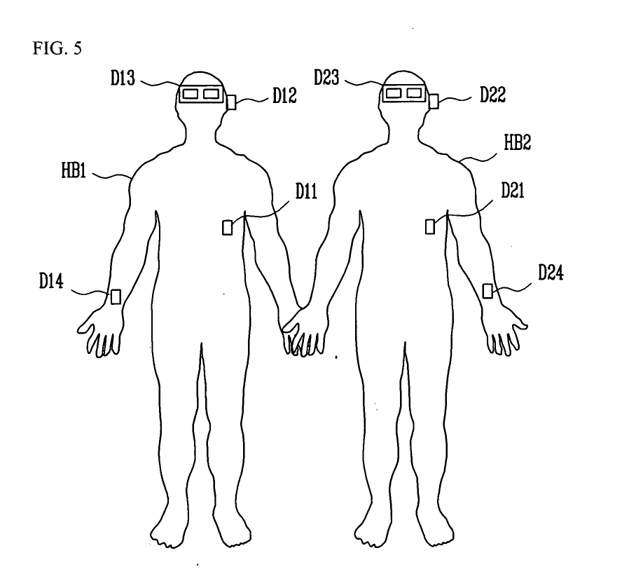

FIG. 5 is a schematic diagram illustrating a communication system using a near field according to another embodiment of the present invention.

Referring to FIG. 5, when a human body HB1 having a plurality of peripheral devices D11 to D14 for human body communication are in contact with or close to another human body HB2 having a plurality of peripheral devices D21 to D24 for human body communication, the peripheral devices D11 to D14 and D21 to D24 on the two human bodies HB1 and HB2 recognize the two human bodies HB1 and HB2 as one communication channel. This may be appreciated such that a network is configured to have one human body with the peripheral devices twice as many as the adjacent peripheral devices.

As described above, according to a communication system using a near field and a method thereof of the present invention, the communication system uses a conductive medium, i.e., a human body, and is composed of a plurality of peripheral devices having communication devices for transmitting/receiving predetermined data signals through a near field formed around the human body, respectively, using a carrier sense multiple access with collision detection (CSMA/CD) method. Therefore, it is possible to solve a directional problem of an antenna when the wireless system is used and achieve miniaturization. In addition, it is also possible to enhance communication efficiency by using the most appropriate frequency to the human communication without collision of transmitting and receiving signals between the plurality of peripheral devices.

While the communication system using a near field and a method thereof have been described with reference to exemplary embodiments, these embodiments are illustrative only, but not for limiting the scope of the present invention claimed in the following claims. Therefore, those skilled in the art will appreciate that a variety of modifications and the equivalents thereof may be made. Thus, the scope of the present invention should be defined by the appended claims.

What is claimed is:

1. A communication system using a near field, comprising:
at least one medium having conductivity; and
a plurality of peripheral devices arranged around the medium and having a communication device used to transmit and receive a predetermined data signal using a carrier sense multiple access with collision detection (CSMA/CD) method through the near field formed around the medium.

2. The communication system according to claim 1, wherein the medium is composed of a human body.

3. The communication system according to claim 1, wherein the predetermined data signal includes at least one selected from a group consisting of a character signal, a video signal, an audio signal and a physiological signal detected from a human body.

4. The communication system according to claim 1, wherein each of the peripheral device is at least one selected from a group consisting of a communication device, an acoustic device, an image display device, an arithmetic processing device, and a medical sensor.

5. The communication system according to claim 1, wherein the communication devices includes:
an interface unit for coupling with the medium;
a transmission unit for modulating the predetermined data signal using a predetermined frequency;
a receiving unit for receiving the modulated data signal from the transmission unit through the interface unit to demodulate to an original signal;
a signal collision detection unit for comparing respective data signals transmitted and received from the transmission unit and the receiving unit to output a predetermined collision detection signal for preventing collision of the transmitted and received data signals between the plurality of peripheral devices; and
a communication control unit for controlling the transmission unit and the receiving unit, respectively, based on the outputted collision detection signal, to periodically check a communication state of the medium.

6. The communication system according to claim 5, wherein the interface unit includes an electrode having good conductivity.

7. The communication system according to claim 5, wherein the data signals outputted from the transmission unit are modulated using the carrier frequency which is an appropriate frequency to a human body communication, such as amplitude shift keying (ASK) and frequency shift keying (FSK) and son on.

8. The communication system according to claim 5, wherein the signal collision detection unit compares, bit by bit, currently transmitted data signals and the data signals received from the receiving unit at the time of transmitting the data signals transmitted from the transmission unit, and when the bit of the data signals different from that of the currently transmitted data signals is received, a predetermined collision detection signal is outputted to the communication control unit.

9. A communication method using a near field, comprising:
transmitting a plurality of data signals through a near field formed around at least one medium having conductivity, respectively;
receiving the respective data singles transmitted through the medium; and
controlling the transmitted and received data signals using a carrier sense multiple access with collision detection (CSMA/CD) method to prevent collision between the transmitted and received data signals.

10. A communication method using a near field in a communication system arranged around at least one medium having conductivity and comprising a plurality of peripheral devices having a communication device for transmitting and receiving a predetermined data signal through the near field formed around the medium, the communication method comprising:
(a) designating a priority for each of the peripheral devices, and setting a time to check a communication state of the medium to be different from each other based on the designated priority;
(b) determining whether data signals to transmit to the plurality of peripheral devices exist for each of the communication devices, and in the case that the data signals to transmit do not exist, maintaining a wait state for a predetermined time, and then determining again whether the data signals to transmit to the plurality of peripheral devices exit;
(c) as a result of the determination in the step (a), in the case that the data signals to transmit to the plurality of peripheral devices exist, preparing to transmit the data signals to the corresponding peripheral device;
(d) determining a communication state of the medium for each of the communication devices, and in the case that the communication state between the peripheral devices through the medium is busy, waiting for a predetermined time and then returning to the step (c);
(e) as a result of the determination in the step (d), in the case that the communication state between the peripheral devices through the medium is idle, checking a communication state of the medium for a time to check the established communication state of the medium;
(f) determining the communication state of the medium for each of the communication devices, and in the case that the communication state between the peripheral devices through the medium is busy, waiting for a predetermined time to return to the step (c); and
(g) as a result of the determination in the step (g), in the case that the communication state between the peripheral devices through the medium is idle, completing the transmission of the data signal.

11. The communication method according to claim 10, wherein the priority is designated for each of the peripheral devices using a certain signal generator in the step (a).

12. The communication method according to claim 10, wherein, in the step (c), preparing of the data transmission is performed by generating packet data signals in a packet unit composed of a plurality of byte data signals through the corresponding communication device, and converting the packet data signals into high-frequency signals appropriate to the communication with the medium.

13. The communication method according to claim 10, wherein the medium is composed of a human body.
